(19) United States
(12) Patent Application Publication
(10) Pub. No.: US 2025/0193427 A1
(43) Pub. Date: Jun. 12, 2025

(54) POINT CLOUD DECODING DEVICE, POINT CLOUD DECODING METHOD, AND PROGRAM

(71) Applicant: KDDI CORPORATION, Tokyo (JP)

(72) Inventors: Chihiro NAKATSUKA, Fujimino-shi (JP); Kyohei UNNO, Fujimino-shi (JP); Satoshi KOMORITA, Fujimino-shi (JP); Kei KAWAMURA, Fujimino-shi (JP)

(73) Assignee: KDDI CORPORATION, Tokyo (JP)

(21) Appl. No.: 19/059,476

(22) Filed: Feb. 21, 2025

Related U.S. Application Data
(63) Continuation of application No. PCT/JP2023/029765, filed on Aug. 17, 2023.

(30) Foreign Application Priority Data
Oct. 13, 2022 (JP) 2022-165090

(51) Int. Cl. H04N 19/44; H04N 19/159; H04N 19/172; H04N 19/597; H04N 19/70

(52) U.S. Cl. CPC H04N 19/44; H04N 19/159; H04N 19/172; H04N 19/597; H04N 19/70

(57) ABSTRACT

A point cloud decoding device 200 includes: a circuit that performs inter prediction using a plurality of reference frames during Predictive coding.

### CROSS-REFERENCE TO RELATED APPLICATIONS

The present application is a continuation of PCT Application No. PCT/JP2023/029765, filed on Aug. 17, 2023, which claims the benefit of Japanese patent application No. 2022-165090 filed on Oct. 13, 2022, the entire contents of each application being incorporated herein by reference in its entirety.

### TECHNICAL FIELD

The present invention relates to a point cloud decoding device, a point cloud decoding method, and a program.

### BACKGROUND ART

Non Patent Literature 1: “G-PCC codec description, ISO/IEC JTC1/SC29/WG7 N00271” discloses a technique for performing Predictive coding.

Furthermore, Non Patent Literature 2: “G-PCC 2nd Edition codec description, ISO/IEC JTC1/SC29/WG7 N00314” discloses a technique of performing inter prediction using a predictor selected from one reference frame during Predictive coding.

### SUMMARY OF THE INVENTION

However, the technique disclosed in Non Patent Literature 1 discloses a technique for performing Predictive coding does not perform inter prediction, and therefore has a problem that compression performance of encoding is undermined.

Furthermore, according to the technique disclosed in Non Patent Literature 2, since there is only one reference frame, there has been a problem that, in a case where points on the reference frame include a lot of noise or a defect due to shielding or the like, an appropriate predictor cannot be selected and compression performance of encoding is undermined.

Therefore, the present invention has been made in view of the above-described problems, and an object of the present invention is to provide a point cloud decoding device, a point cloud decoding method, and a program that can improve compression performance of encoding.

The first aspect of the present invention is summarized as a point cloud decoding device including: a circuit that performs inter prediction using a plurality of reference frames during Predictive coding.

The second aspect of the present invention is summarized as a point cloud decoding method including: performing inter prediction using a plurality of reference frames during Predictive coding.

The third aspect of the present invention is summarized as a program stored on a non-transitory computer-readable medium for causing a computer to function as a point cloud decoding device, wherein the point cloud decoding device including: a circuit that performs inter prediction using a plurality of reference frames during Predictive coding.

According to the present invention, it is possible to provide a point cloud decoding device, a point cloud decoding method, and a program that can improve compression performance of encoding.

### BRIEF DESCRIPTION OF THE DRAWINGS

FIG. 1 is a diagram illustrating an example of a configuration of a point cloud processing system 10 according to an embodiment.

FIG. 2 is a diagram illustrating an example of functional blocks of a point cloud decoding device 200 according to the embodiment.

FIG. 3 is a diagram illustrating an example of a configuration of encoded data (bit stream) received by a geometry information decoding unit 2010 of the point cloud decoding device 200 according to the embodiment.

FIG. 4 is a diagram illustrating an example of a syntax configuration of a GPS 2011.

FIG. 5 is a flowchart illustrating an example of processing in a tree synthesizing unit 2020 of the point cloud decoding device 200 according to the embodiment.

FIG. 6 is a flowchart illustrating an example of processing in step S502.

FIG. 7 is a view illustrating an example of a method for storing a decoded frame in a frame buffer 2120.

FIG. 8-1 is a diagram illustrating an example of global motion compensation processing in step S504.

FIG. 8-2 is a diagram illustrating an example of global motion compensation processing in step S504.

FIG. 9 is a flowchart illustrating an example of slice data decoding processing in step S505.

FIG. 10 is a flowchart illustrating an example of coordinate prediction processing in step S905.

FIG. 11 is a diagram illustrating an example of inter prediction processing in step S1002.

FIG. 12-1 is a diagram illustrating an example of inter prediction processing in step S1002.

FIG. 12-2 is a diagram illustrating an example of inter prediction processing in step S1002.

FIG. 13-1 is a diagram illustrating an example of processing of allocating an index to a predictor obtained by inter prediction in step S1004.

FIG. 13-2 is a diagram illustrating an example of processing of allocating the index to the predictor obtained by the inter prediction in step S1004.

FIG. 13-3 is a diagram illustrating an example of processing of allocating the index to the predictor obtained by the inter prediction in step S1004.

FIG. 14 is a diagram illustrating an example of functional blocks of a point cloud encoding device 100 according to the present embodiment.

### DESCRIPTION OF EMBODIMENTS

An embodiment of the present invention will be described hereinbelow with reference to the drawings. Note that the constituent elements of the embodiment below can, where appropriate, be substituted with existing constituent elements and the like, and that a wide range of variations, including combinations with other existing constituent elements, is possible. Therefore, there are no limitations placed on the content of the invention as in the claims on the basis of the disclosures of the embodiment hereinbelow.

### First Embodiment

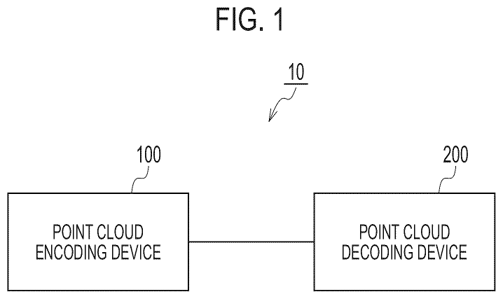

Hereinafter, a point cloud processing system 10 according to a first embodiment of the present invention will be described with reference to FIGS. 1 to 14. FIG. 1 is a diagram illustrating the point cloud processing system 10 according to an embodiment of the present embodiment.

As illustrated in FIG. 1, the point cloud processing system 10 includes a point cloud encoding device 100 and a point cloud decoding device 200.

The point cloud encoding device 100 is configured to generate encoded data (bit stream) by encoding an input point cloud signal. The point cloud decoding device 200 is configured to generate an output point cloud signal by decoding the bit stream.

Note that the input point cloud signal and the output point cloud signal include position information and attribute information of each point in a point cloud. The attribute information is, for example, color information or a reflectance of each point.

Here, such a bit stream may be transmitted from the point cloud encoding device 100 to the point cloud decoding device 200 through a channel. Furthermore, the bit stream may be stored in a storage medium, and then provided from the point cloud encoding device 100 to the point cloud decoding device 200.

### Point Cloud Decoding Device 200

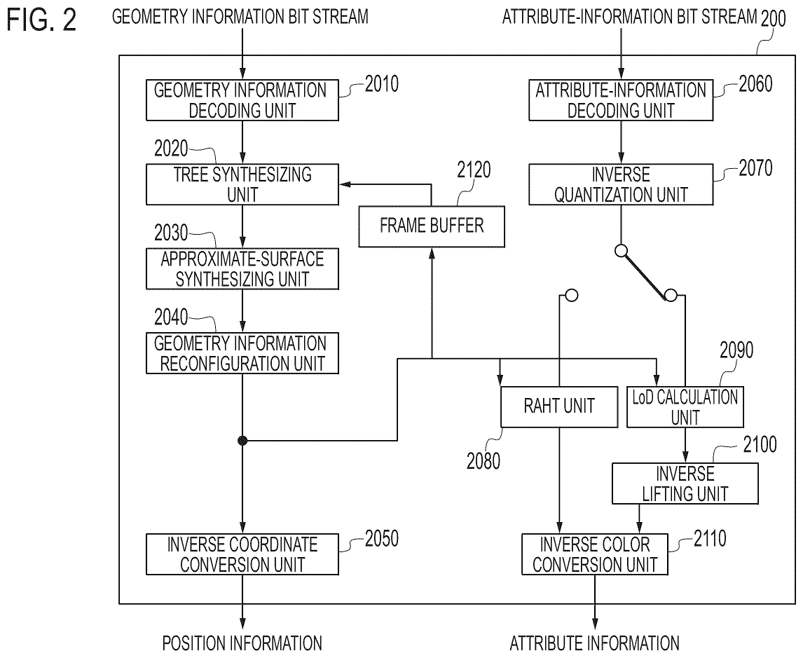

Hereinafter, the point cloud decoding device 200 according to the present embodiment will be described with reference to FIG. 2. FIG. 2 is a diagram illustrating an example of functional blocks of the point cloud decoding device 200 according to the present embodiment.

As illustrated in FIG. 2, the point cloud decoding device 200 includes a geometry information decoding unit 2010, a tree synthesizing unit 2020, an approximate-surface synthesizing unit 2030, a geometry information reconfiguration unit 2040, an inverse coordinate conversion unit 2050, an attribute-information decoding unit 2060, an inverse quantization unit 2070, an RAHT unit 2080, an LoD calculation unit 2090, an inverse lifting unit 2100, an inverse color conversion unit 2110, and a frame buffer 2120.

The geometry information decoding unit 2010 is configured to receive an input of a bit stream related to geometry information (geometry information bit stream) among bit streams output from the point cloud encoding device 100, and decode a syntax.

Decoding processing is, for example, context-adaptive binary arithmetic decoding processing. Here, for example, the syntax includes control data (flags or parameters) for controlling decoding processing of position information.

The tree synthesizing unit 2020 is configured to receive an input of the control data decoded by the geometry information decoding unit 2010 and an occupancy code indicating in which node in a tree described later a point cloud exists, and generate tree information indicating in which region in a decoding target space a point exists.

Note that the tree synthesizing unit 2020 may be configured to perform decoding processing of the occupancy code inside.

This processing can generate tree information by recursively repeating processing of partitioning a decoding target space into cuboids, determining whether or not a point exists in each cuboid referring to the occupancy code, dividing the cuboid in which the point exists into a plurality of cuboids, and referring to the occupancy code.

Here, inter prediction described later may be used at a time of decoding the occupancy code.

In the present embodiment, it is possible to use a method called “Octree” of recursively performing octree division using the above-described cuboids as cubes at all times, and a method called “QtBt” of performing quadtree division and binary tree division in addition to octree division. Whether or not to use “QtBt” is transmitted as control data from the point cloud encoding device 100 side.

Alternatively, the tree synthesizing unit 2020 is configured to, when the control data designates use of Predictive geometry coding, decode the coordinates of each point based on an arbitrary tree configuration determined by the point cloud encoding device 100.

The approximate-surface synthesizing unit 2030 is configured to generate approximate-surface information using the tree information generated by the tree synthesizing unit 2020, and decode a point cloud based on this approximate-surface information.

For example, the approximate-surface information is information obtained by approximating and expressing a region in which the point cloud exists by a small plane instead of decoding an individual point cloud in a case where a point cloud is densely distributed on the surface of an object when three-dimensional point cloud data of the object or the like is decoded.

More specifically, the approximate-surface synthesizing unit 2030 can generate the approximate-surface information and decode the point cloud by, for example, a method called “Trisoup”. A specific “Trisoup” processing example will be described later. Furthermore, when a sparse point cloud acquired by Lidar or the like is decoded, this processing can be omitted.

The geometry information reconfiguration unit 2040 is configured to reconfigure the geometry information (position information on the coordinate system assumed by the decoding processing) of each point of decoding target point cloud data based on the tree information generated by the tree synthesizing unit 2020 and the approximate-surface information generated by the approximate-surface synthesizing unit 2030.

The inverse coordinate conversion unit 2050 is configured to receive an input of the geometry information reconfigured by the geometry information reconfiguration unit 2040, convert the coordinate system assumed by the decoding processing into a coordinate system of the output point cloud signal, and output the position information.

The frame buffer 2120 is configured to receive an input of the geometry information reconfigured by the geometry information reconfiguration unit 2040 to store as a reference frame. The stored reference frame is read from the frame buffer 2130 and used as a reference frame in a case where the tree synthesizing unit 2020 performs inter prediction on temporally different frames.

Here, a reference frame of which time is used for each frame may be determined based on, for example, control data transmitted as a bit stream from the point cloud encoding device 100.

The attribute-information decoding unit 2060 is configured to receive an input of a bit stream (attribute-information bit stream) related to attribute information among the bit streams output from the point cloud encoding device 100, and decode a syntax.

Decoding processing is, for example, context-adaptive binary arithmetic decoding processing. Here, for example, the syntax includes control data (flags and parameters) for controlling decoding processing of the attribute information.

Furthermore, the attribute-information decoding unit 2060 is configured to decode quantized residual information from the decoded syntax.

The inverse quantization unit 2070 is configured to perform inverse quantization processing based on the quantized residual information decoded by the attribute-information decoding unit 2060 and quantization parameters that are one of items of the control data decoded by the attribute-information decoding unit 2060, and generate inversely quantized residual information.

The inversely quantized residual information is output to one of the RAHT unit 2080 and the LoD calculation unit 2090 according to a feature of the decoding target point cloud. To which one of the RAHT unit 2080 and the LoD calculation unit 2090 the inversely quantized residual information is output is designated by the control data decoded by the attribute-information decoding unit 2060.

The RAHT unit 2080 is configured to receive an input of the inversely quantized residual information generated by the inverse quantization unit 2070, and the geometry information generated by the geometry information reconfiguration unit 2040, and decode attribute information of each point by using a type of Haar transform (that is inverse Haar transform at a time of decoding processing) called Region Adaptive Hierarchical Transform (RAHT). As specific RAHT processing, for example, the method described in Non-Patent Literature 1 can be used.

The LoD calculation unit 2090 is configured to receive an input of the geometry information generated by the geometry information reconfiguration unit 2040, and generate a Level of Detail (LoD).

The LoD is information for defining a reference relationship (a point that refers to and a point to be referred to) for implementing predictive coding of predicting attribute information of a certain point from attribute information of another certain point, and encoding or decoding a prediction residual.

In other words, the LoD is information that defines a hierarchical structure in which each point included in the geometry information is classified into a plurality of levels, and as for a point belonging to a lower level, an attribute is encoded or decoded using attribute information of a point belonging to an upper level.

As a specific LoD determination method, for example, the method described in Non Patent Literature 1 described above may be used.

The inverse lifting unit 2100 is configured to decode the attribute information of each point based on a hierarchical structure defined by the LoD using the LoD generated by the LoD calculation unit 2090 and the inversely quantized residual information generated by the inverse quantization unit 2070. As specific inverse lifting processing, for example, the method described in Non Patent Literature 1 described above can be used.

The inverse color conversion unit 2110 is configured to, when the attribute information of the decoding target is color information the point cloud encoding device 100 side is performing color conversion, perform inverse color conversion processing on the attribute information output from the RAHT unit 2080 or the inverse lifting unit 2100. Whether or not to execute this inverse color conversion processing is determined according to the control data decoded by the attribute-information decoding unit 2060.

The point cloud decoding device 200 is configured to decode and output the attribute information of each point in the point cloud by the above processing.

Geometry information Decoding Unit 2010

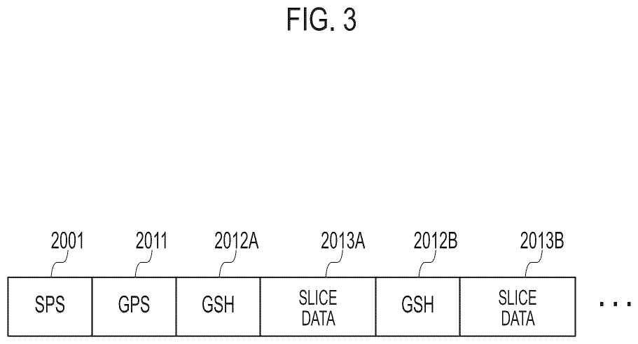

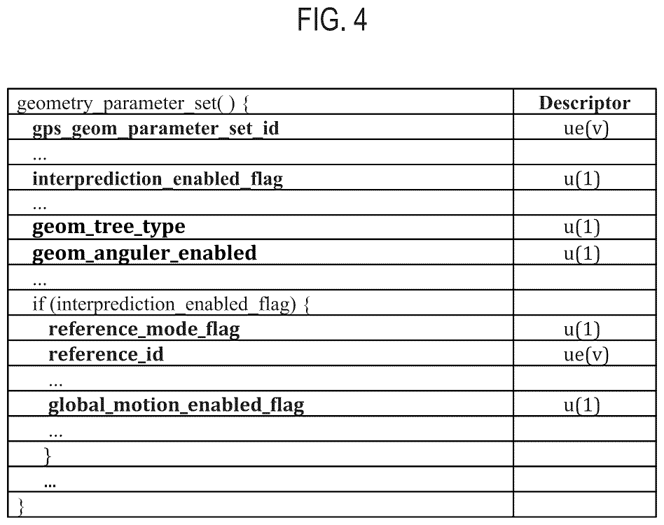

The control data decoded by the geometry information decoding unit 2010 will be described below with reference to FIGS. 3 and 4.

FIG. 3 illustrates an example of a configuration of encoded data (bit stream) received by the geometry information decoding unit 2010.

First, the bit stream may include a GPS 2011. The GPS 2011 is also called a geometry parameter set, and is a set of control data related to decoding of the geometry information. A specific example thereof will be described later. Each GPS 2011 includes at least GPS id information for identifying the individual GPSs 2011 in a case where there are the plurality of GPSs 2011.

Second, the bit stream may include a GSH 2012A/2012B. The GSH 2012A/2012B is also called a geometry slice header or a geometry data unit header, and is a set of control data corresponding to a slice to be described later. Hereinafter, description will be given using the term “slice”, but the slice may be read as a data unit. A specific example thereof will be described later. The GSH 2012A/2012B includes at least GPS id information for designating the GPS 2011 associated with each of the GSH 2012A/2012B.

Third, the bit stream may include slice data 2013A/2013B in addition to the GSH 2012A/2012B. The slice data 2013A/2013B includes data obtained by encoding the geometry information. An example of the slice data 2013A/2013B includes the occupancy code to be described later.

As described above, the bit stream is configured such that each slice data 2013A/2013B is associated with the GSH 2012A/2012B and the GPS 2011 one by one.

As described above, since which GPS 2011 is referred to in the GSH 2012A/2012B is designated by the GPS id information, the GPS 2011 common to a plurality of items of slice data 2013A/2013B can be used.

In other words, the GPS 2011 does not necessarily need to be transmitted for each slice. For example, the bit stream may be configured such that the GPS 2011 is not encoded immediately before the GSH 2012B and the slice data 2013B as in FIG. 3.

Note that the configuration in FIG. 3 is merely an example. As long as each slice data 2013A/2013B is configured to be associated with the GSH 2012A/2012B and the GPS 2011, an element other than those described above may be added as a constituent element of the bit stream.

For example, as illustrated in FIG. 3, the bit stream may include a Sequence Parameter Set (SPS) 2001. Furthermore, similarly, the bit stream may have a configuration different from that in FIG. 3 at the time of transmission. Furthermore, the bit stream may be synthesized with a bit stream decoded by the attribute-information decoding unit 2060 described later and transmitted as a single bit stream.

FIG. 4 illustrates an example of a syntax configuration of the GPS 2011.

Note that syntax names described below are merely examples. The syntax names may vary as long as the functions of the syntaxes described below are similar.

The GPS 2011 may include GPS id information (gps_geom_parameter_set_id) for identifying each GPS 2011.

Note that a Descriptor column in FIG. 4 indicates how each syntax is encoded. ue(v) means an unsigned 0-order exponential-Golomb code, and u(1) means a 1-bit flag.

The GPS 2011 may include a flag (interprediction_enabled_flag) that controls whether or not to perform inter prediction in the tree synthesizing unit 2020.

For example, when a value of interprediction_enabled_flag is “zero”, it may be defined that inter prediction is not performed, and when a value of interprediction_enabled_flag is “one”, it may be defined that inter prediction is performed.

Note that interprediction_enabled_flag may be included in the SPS 2001 instead of the GPS 2011.

The GPS 2011 may include a flag (geom_tree_type) for controlling a tree type in the tree synthesizing unit 2020. For example, when the value of geom_tree_type is “one”, it may be defined that Predictive coding is used, and when the value of geom_tree_type is “zero”, it may be defined that Predictive coding is not used.

Note that geom_tree_type may be included in the SPS 2001 instead of the GPS 2011.

The GPS 2011 may include a flag (geom_angular_enabled) for controlling whether or not to perform processing in an Angular mode in the tree synthesizing unit 2020.

For example, when the value of geom_angular_enabled is “one”, it may be defined that Predictive coding is performed in the Angular mode, and when the value of geom_angular_enabled is “zero”, it may be defined that Predictive coding is not performed in the Angular mode.

Note that geom_angular_enabled may be included in the SPS 2001 instead of the GPS 2011.

The GPS 2011 may include a flag (reference_mode_flag) for controlling the number of reference frames for inter prediction in the tree synthesizing unit 2020.

For example, when a value of reference_mode_flag is “zero”, the number of reference frames may be defined as one, and when a value of reference_mode_flag is “one”, the number of reference frames may be defined as two.

Note that reference_mode_flag may be included in the SPS 2001 instead of the GPS 2011.

The GPS 2011 may include a syntax (reference_id) that defines a reference frame used for inter prediction in the tree synthesizing unit 2020.

For example, reference_id may be expressed as an index number indicating a frame to be used as a reference frame among frames included in the frame buffer 2120. The index number may be configured such that the index numbers the number of which is the same as the number of reference frames defined by reference_mode_flag is included.

Note that reference_id may be included in the SPS 2001 instead of the GPS 2011.

Instead of reference_id, the number of frames defined by reference_mode_flag may be selected as reference frames from frames processed immediately before a current frame.

The GPS 2011 may include a flag (global_motion_enabled_flag) that controls whether or not to perform global motion compensation for inter prediction in the tree synthesizing unit 2020.

For example, when a value of global_motion_enabled_flag is “zero”, it may be defined that global motion compensation is not performed, and when a value of global_motion_enabled_flag is “one”, it may be defined that global motion compensation is performed.

When global motion compensation is performed, each slice data may include a global motion vector.

Note that global_motion_enabled_flag may be included in the SPS 2001 instead of the GPS 2011.

### Tree Synthesizing Unit 2020

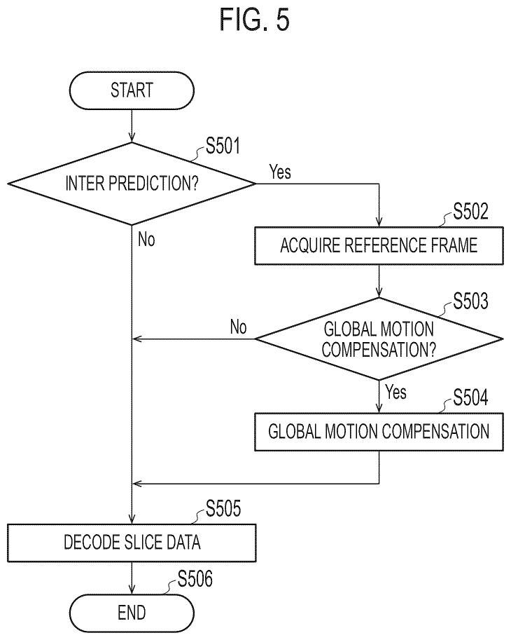

Hereinafter, processing of the tree synthesizing unit 2020 will be described with reference to FIGS. 5 to 13. FIG. 5 is a flowchart illustrating an example of processing in the tree synthesizing unit 2020. Note that an example in a case where trees are synthesized using “Predictive geometry coding” will be described below.

Note that, instead of “Predictive coding”, names such as “Predictive geometry”, “Predictive geometry coding”, and “Predictive tree” may be used.

As illustrated in FIG. 5, in step S501, the tree synthesizing unit 2020 determines whether or not to use inter prediction based on the value of interprediction_enabled_flag.

The processing proceeds to step S502 when the tree synthesizing unit 2020 determines to use the inter prediction, and proceeds to step S505 when the tree synthesizing unit 2020 determines not to use the inter prediction.

In step S502, the tree synthesizing unit 2020 acquires the number of reference frames that is based on the value of reference_mode_flag. Specific processing in step S502 will be described later. After the tree synthesizing unit 2020 acquires the reference frame, the processing proceeds to step S503.

In step S503, the tree synthesizing unit 2020 determines whether or not to perform global motion compensation based on global_motion_enabled_flag.

The processing proceeds to step S504 when the tree synthesizing unit 2020 determines to perform global motion compensation, and proceeds to step S505 when the tree synthesizing unit 2020 determines not to perform the global motion compensation.

In step S504, the tree synthesizing unit 2020 performs global motion compensation on the reference frame acquired in step S502. Specific processing in step S504 will be described later. After the tree synthesizing unit 2020 performs global motion compensation, the processing proceeds to step S505.

In step S505, the tree synthesizing unit 2020 decodes the slice data. Specific processing in step S505 will be described later. After the tree synthesizing unit 2020 decodes the slice data, the processing proceeds to step S506.

In step S506, the tree synthesizing unit 2020 ends the processing. Note that the processing in steps S503 and S504, that is, determination and execution of global motion compensation may be performed during the decoding processing of the slice data in step S505.

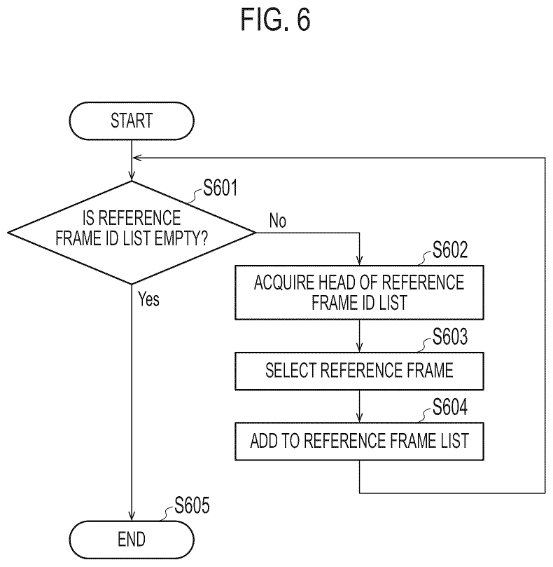

FIG. 6 is a flowchart illustrating an example of the processing in step S502.

In step S601, the tree synthesizing unit 2020 determines whether or not a reference frame ID list defined by reference_id is empty.

The processing proceeds to step S605 when the tree synthesizing unit 2020 determines that the reference frame ID list is empty, and proceeds to step S602 when the tree synthesizing unit 2020 determines that the reference frame ID list is not empty.

In step S602, the tree synthesizing unit 2020 extracts an element at a head of the reference frame ID list to set as the reference frame ID. After the tree synthesizing unit 2020 completes setting the reference frame ID, the processing proceeds to step S603.

In step S603, the tree synthesizing unit 2020 selects a reference frame from the frame buffer 2120 based on the reference frame ID. A method for storing the decoded frame in the frame buffer 2120 will be described later. After the tree synthesizing unit 2020 selects the reference frame, the processing proceeds to step S604.

In step S604, the tree synthesizing unit 2020 adds the selected reference frame to the reference frame list. After the tree synthesizing unit 2020 completes the addition to the reference frame list, the processing proceeds to step S601.

In step S605, the tree synthesizing unit 2020 ends the processing in step S502.

As described above, the tree synthesizing unit 2020 may be configured to perform inter prediction using a plurality of reference frames during Predictive coding. Consequently, it is possible to improve inter prediction performance.

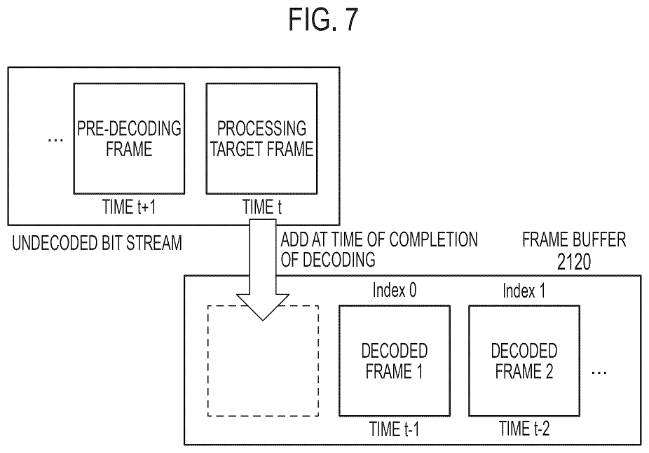

FIG. 7 is a diagram illustrating an example of a method for storing a decoded frame in the frame buffer 2120.

The frame buffer 2120 may store previously decoded frames as a list.

The frames may be decoded in chronological order of a time t, a time t+1, and . . . , and the decoded frames may be added in order from the head of the list in the frame buffer 2120.

In such a list, indices may be allocated in order from the head.

A limitation of a maximum number is placed on the length of the list, and when the list exceeds the maximum number, elements may be deleted in order from elements at the end of the list.

Addition of the decoded frame to the frame buffer 2120 may not be performed on all frames, and every time decoding of a predetermined number of frames is completed, one or a predetermined number of frames may be added.

As described above, the frame buffer 2120 may be configured to hold a plurality of decoded frames in order from the most recently decoded frame, and reject an old frame when the number of frames exceeds the maximum number of frames that can be held. Consequently, it is possible to use a plurality of reference frames during inter prediction while suppressing memory usage.

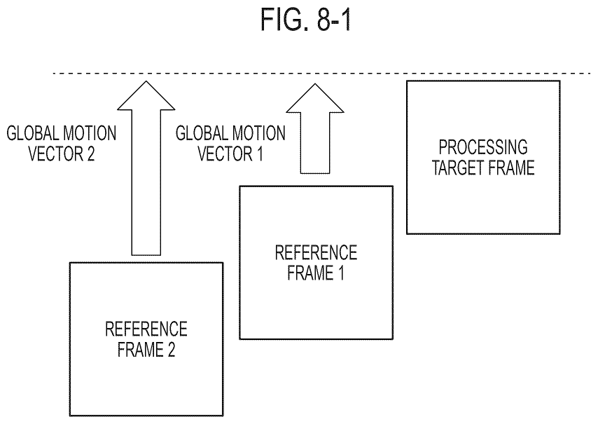

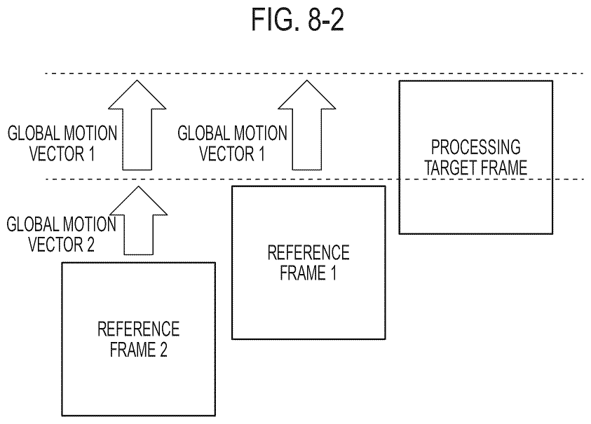

FIG. 8 is a diagram illustrating an example of global motion compensation processing in step S504.

Here, the global motion compensation is processing of correcting global positional shift for each frame.

In step S504, the tree synthesizing unit 2020 corrects the reference frame to resolve the global positional shift between the reference frame acquired in step S502 and the processing target frame using a global motion vector decoded by the geometry information decoding unit 2010.

For example, the tree synthesizing unit 2020 may add corresponding global motion vectors to all coordinates of the reference frame.

In a case where there are a plurality of reference frames, the tree synthesizing unit 2020 may use, for example, a method illustrated in FIG. 8-1 or a method illustrated in FIG. 8-2 as a correction method.

The method illustrated in FIG. 8-1 is a method for adding, to each of the plurality of reference frames 1 and 2, global motion vectors 1 and 2 for the processing target frame. Consequently, it is possible to apply global motion compensation to a plurality of reference frames.

The method illustrated in FIG. 8-2 is a method for adding to the reference frame 1 the global motion vector 1 for the processing target frame, and adding to the reference frame 2 the global motion vector 1 and the global motion vector 2 of the reference frame 2 for the reference frame 1. Consequently, it is possible to apply global motion compensation to a plurality of reference frames while suppressing a data amount at a time of transmission of the global motion vector.

The method illustrated in FIG. 8-2 holds the global motion vector 1 of the reference frame (reference frame 1) at a head for the processing target frame, and reuses the global motion vector 1 in subsequent processing. Consequently, it is possible to suppress the data amount at the time of transmission of the global motion vector. When, for example, a processing target moves to a subsequent frame and the processing target frame and the reference frame 1 are selected as the reference frame 1 and the reference frame 2, respectively, the global motion vector 1 may be reused as the global motion vector 2.

Note that, in a case where the method illustrated in FIG. 8-1 and the method illustrated in FIG. 8-2 are adopted, the global motion vector may include Index or the like indicating which reference frame the global motion vector is associated with.

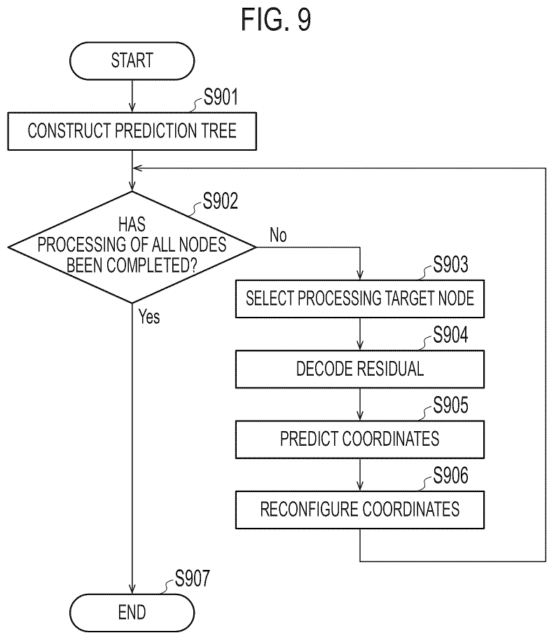

FIG. 9 is a flowchart illustrating an example of slice data decoding processing in step S505.

As illustrated in FIG. 9, in step S901, the tree synthesizing unit 2020 constructs a prediction tree associated with slice data.

The slice data may include a list in which the number of child nodes of each node of the prediction tree is arranged in depth-first order. As a method for constructing the prediction tree, a method for adding, to each node, child nodes the number of which is designated by the above list in the depth-first order starting from a root node may be adopted.

After the tree synthesizing unit 2020 completes constructing the prediction tree, the processing proceeds to step S902.

In step S902, the tree synthesizing unit 2020 determines whether or not processing of all nodes of the prediction tree has been completed.

In a case where the tree synthesizing unit 2020 determines that the processing of all the nodes of the prediction tree has been completed, the processing proceeds to step S907, and in a case where the tree synthesizing unit 2020 determines that the processing of all the nodes of the prediction tree has not been completed, the processing proceeds to step S903.

In step S903, the tree synthesizing unit 2020 selects a processing target node from the prediction tree.

The tree synthesizing unit 2020 may set a processing order of the nodes of the prediction tree as the depth-first order starting from the root node, or may select a node next to a lastly processed node as the processing target node.

After the tree synthesizing unit 2020 completes selecting the processing target node, the processing proceeds to step S904.

In step S904, the tree synthesizing unit 2020 decodes a prediction residual of coordinates of a point corresponding to the processing target node.

Slice data may include a list in which prediction residuals of respective nodes of a prediction tree are arranged in depth-first order.

After the tree synthesizing unit 2020 completes decoding the prediction residual of the processing target node, the processing proceeds to step S905.

In step S905, the tree synthesizing unit 2020 predicts the coordinates of the point corresponding to the processing target node. A specific coordinate prediction method will be described later. After the tree synthesizing unit 2020 completes the coordinate prediction, the processing proceeds to step S906.

In step S906, the tree synthesizing unit 2020 reconfigures the coordinates of the point corresponding to the processing target node. The tree synthesizing unit 2020 may obtain the coordinates of the point based on the residual decoded in step S904 and the sum of the coordinates predicted in step S905.

In a case where the Angular mode is used, the tree synthesizing unit 2020 may reconfigure the coordinates by the methods described in Non Patent Literatures 1 and 2 in consideration of values that are taken by the prediction residual and the prediction coordinates and based on a spherical coordinate system.

In the case where the Angular mode is used, the tree synthesizing unit 2020 may convert the reconfigured coordinates from the spherical coordinate system into the orthogonal coordinate system by the methods described in Non-Patent Literatures 1 and 2.

After the tree synthesizing unit 2020 completes reconfiguring the coordinates, the processing proceeds to step 902.

In step S907, the tree synthesizing unit 2020 ends the processing in step S505.

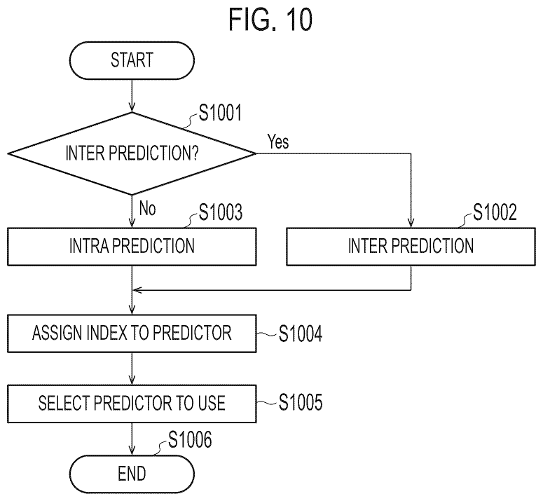

FIG. 10 is a flowchart illustrating an example of coordinate prediction processing in step S905.

As illustrated in FIG. 10, in step S1001, the tree synthesizing unit 2020 determines whether or not to perform inter prediction based on interprediction_enabled_flag.

The processing proceeds to step S1002 when the tree synthesizing unit 2020 determines to perform inter prediction, and proceeds to step S1003 when the tree synthesizing unit 2020 determines not to perform inter prediction.

In step S1002, the tree synthesizing unit 2020 performs inter prediction of predicting the coordinates of the processing target node based on the coordinates of the nodes of the reference frame. Here, the node used for prediction is referred to as a predictor. There may be a plurality of predictors. A specific inter prediction method will be described later.

After the tree synthesizing unit 2020 completes the inter prediction, the processing proceeds to step S1004.

In step S1003, the tree synthesizing unit 2020 performs intra prediction of predicting the coordinates of the processing target node based on a point of a parent node of the processing target node. A node used for prediction is called a predictor. There may be a plurality of predictors. As an intra prediction method, a method similar to those in Non Patent Literatures 1 and 2 may be used.

After the tree synthesizing unit 2020 completes the intra prediction, the processing proceeds to step S1004.

In step S1004, the tree synthesizing unit 2020 allocates an index to the predictor obtained by the inter prediction or the intra prediction. As a method for adding an index to a predictor obtained by intra prediction, a method similar to those in Non Patent Literatures 1 and 2 may be used. A specific method for allocating an index to a predictor obtained by inter prediction will be described later.

Note that, in a case where there is only one predictor, the tree synthesizing unit 2020 may skip the processing in step S1004.

After the tree synthesizing unit 2020 completes allocating the index to the predictor, the processing proceeds to step S1005.

In step S1005, the tree synthesizing unit 2020 selects a predictor to be used.

Here, in a case where there is only one predictor, the tree synthesizing unit 2020 may select this predictor.

On the other hand, in a case where there are a plurality of predictors, the slice data may include one index of a predictor, and the tree synthesizing unit 2020 may select a predictor associated with this index.

The coordinates of the selected one predictor may be a prediction value of the coordinates of the processing target node.

After the tree synthesizing unit 2020 completes selecting the predictor, the processing proceeds to step S1006.

In step S1006, the tree synthesizing unit 2020 ends the processing in step S905.

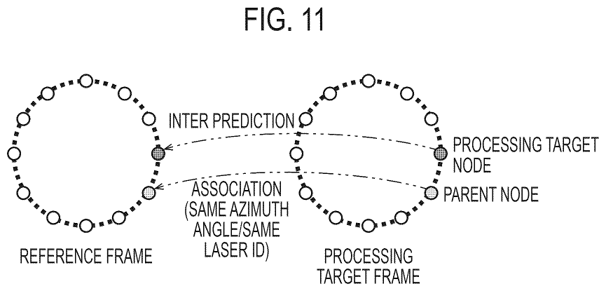

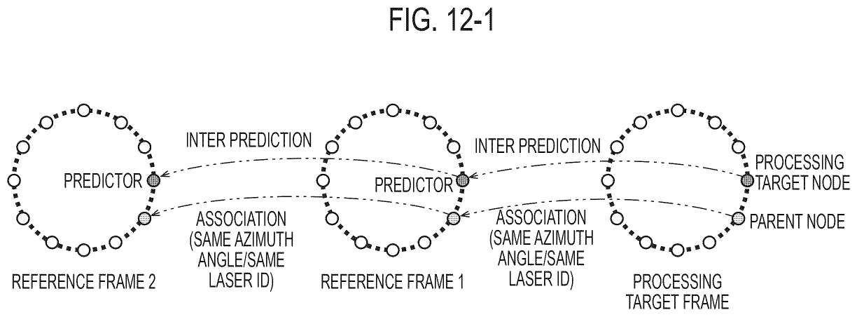

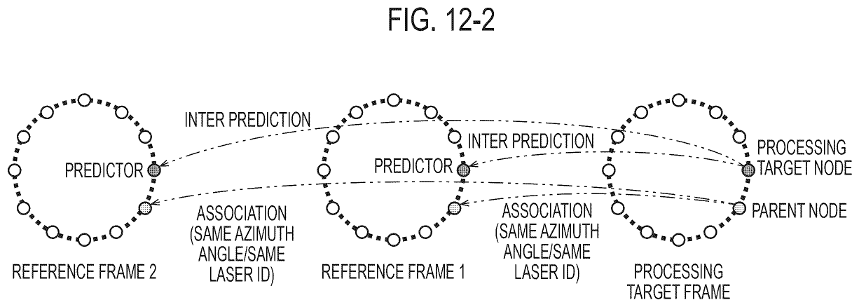

FIGS. 11 and 12 are diagrams illustrating an example of the inter prediction processing in step S1002.

FIG. 11 is a diagram illustrating an example of inter prediction processing in a case where there is one reference frame.

The tree synthesizing unit 2020 may select a node corresponding to the parent node of the processing target node from the reference frame, and may use a child node of the selected node or a child node and a grandchild node of the selected node as a predictor.

The tree synthesizing unit 2020 may associate the parent node of the processing target frame and the node of the reference frame based on information of a decoded point associated with this node, and associate the nodes having the same information of the point or having close information of the point.

The tree synthesizing unit 2020 may use coordinates as the information of the point, and may use a laser ID or an azimuth angle in the case of the Angular mode.

FIG. 12 is a diagram illustrating an example of inter prediction processing in a case where there are a plurality of reference frames.

In the example of FIG. 12-1, as a method for selecting the node corresponding to the parent node of the processing target node from each reference frame, the tree synthesizing unit 2020 selects from the reference frame 1 the node corresponding to the parent node of the processing target node, and selects from the reference frame 2 a node corresponding to the node selected from the reference frame 1.

The tree synthesizing unit 2020 uses a child node of a node selected from each reference frame or a child node and a grandchild node of this node as a predictor. Consequently, it is possible to select a predictor from a plurality of reference frames.

In the example of FIG. 12-2, as the method for selecting the node corresponding to the parent node of the processing target node from each reference frame, the tree synthesizing unit 2020 selects a node corresponding to the parent node of the processing target node from the reference frame 1 and the reference frame 2. Furthermore, the tree synthesizing unit 2020 uses a child node of a node associated from each reference frame or a child node and a grandchild node of this node as a predictor. Consequently, it is possible to select a predictor from a plurality of reference frames. The tree synthesizing unit 2020 may use all the predictors obtained from the plurality of reference frames as predictors, or may aggregate or select all the predictors.

As an aggregation method, the tree synthesizing unit 2020 may use, for example, a new predictor obtained by taking an average of all the predictors instead of using all the predictors.

The tree synthesizing unit 2020 may use a new predictor obtained by taking an average of child nodes or grandchild nodes in each reference frame.

Here, the tree synthesizing unit 2020 may take a weighted average such that more importance is attached to a predictor obtained from a reference frame temporally closer to the processing target frame.

As a selection method, for example, the tree synthesizing unit 2020 may use a child node and a grandchild node as a predictor from the reference frame 1 and use only a child node as a predictor from the reference frame 2 such that, for example, a reference frame temporally closer to the processing target frame includes more predictors.

The tree synthesizing unit 2020 may perform ranking on all predictors obtained from the plurality of reference frames based on a certain criterion, and select a designated number of predictors from an upper level in advance. Here, as the certain criterion, for example, a value of an azimuth angle may be used for a criterion in the case of the Angular mode.

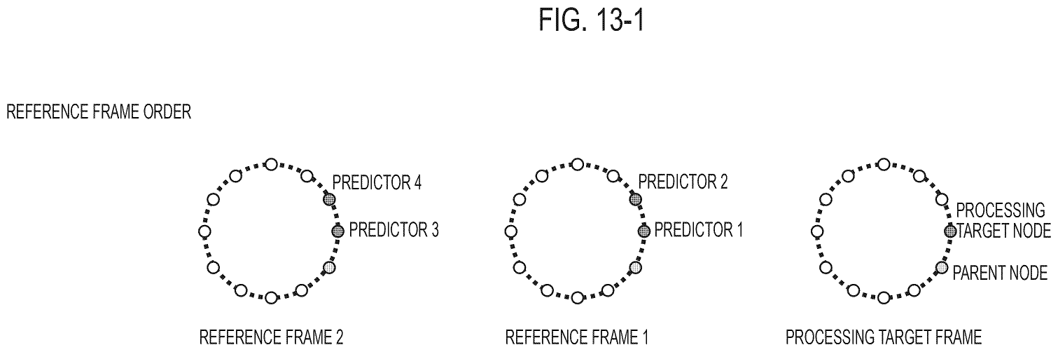

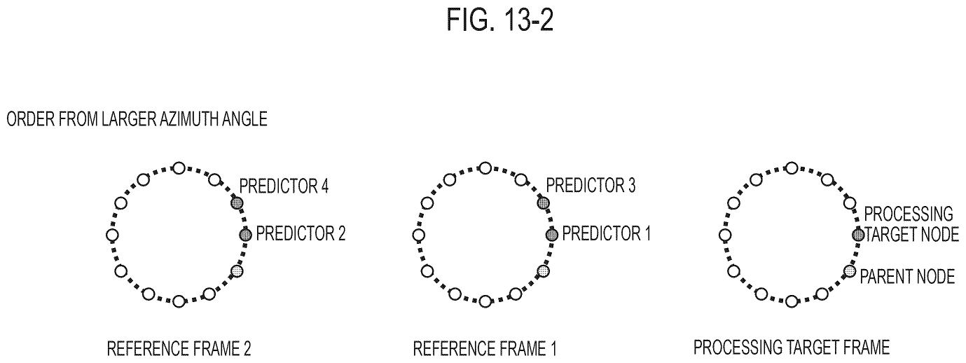

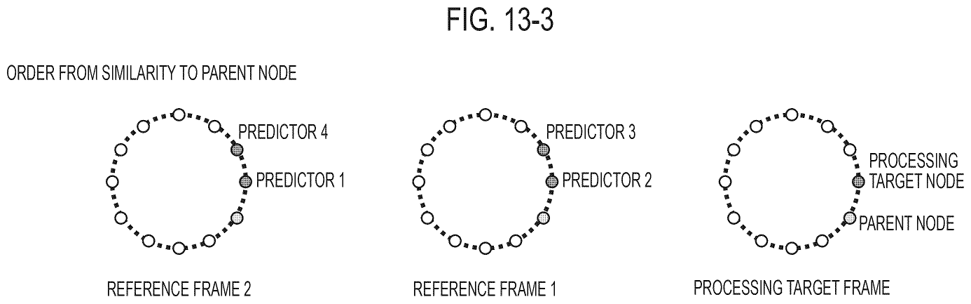

FIG. 13 is a diagram illustrating an example of processing of allocating an index to a predictor obtained by inter prediction in step S1004.

FIG. 13-1 illustrates a method for allocating indices to predictors in order of reference frames to which the predictors belong. The tree synthesizing unit 2020 may allocate indices to predictors belonging to the same reference frame in order of child nodes and grandchild nodes.

FIG. 13-2 illustrates a method for allocating indices in order from a smaller azimuth angle among information of points that the nodes of the predictors have in the Angular mode.

FIG. 13-3 illustrates a method for allocating indices to predictors whose information of points that the nodes of the predictors have is similar to that of the parent node of the processing target node.

### Point Cloud Encoding Device 100

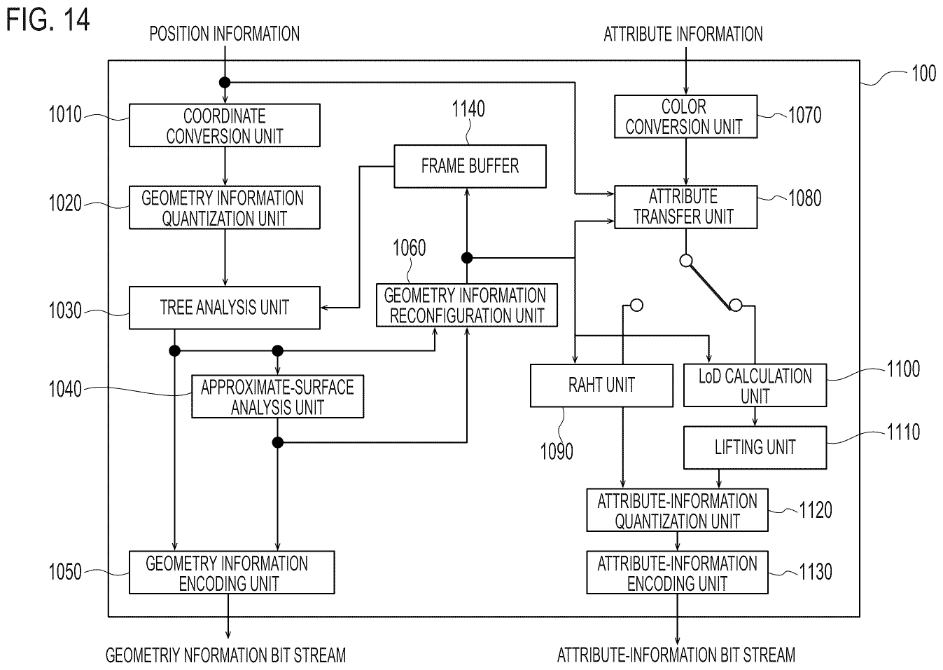

Hereinafter, the point cloud encoding device 100 according to the present embodiment will be described with reference to FIG. 14. FIG. 14 is a diagram illustrating an example of functional blocks of the point cloud encoding device 100 according to the present embodiment.

As illustrated in FIG. 14, the point cloud encoding device 100 includes a coordinate conversion unit 1010, a geometry information quantization unit 1020, a tree analysis unit 1030, an approximate-surface analysis unit 1040, a geometry information encoding unit 1050, a geometry information reconfiguration unit 1060, a color conversion unit 1070, an attribute transfer unit 1080, an RAHT unit 1090, an LoD calculation unit 1100, a lifting unit 1110, an attribute-information quantization unit 1120, an attribute-information encoding unit 1130, and a frame buffer 1140.

The coordinate conversion unit 1010 is configured to perform conversion processing from a three-dimensional coordinate system of an input point cloud into an arbitrary different coordinate system. According to coordinate conversion, for example, x, y, and z coordinates of the input point cloud may be converted into arbitrary s, t, and u coordinates by rotating the input point cloud. Furthermore, as one of variations of the conversion, the coordinate system of the input point cloud may be used as it is.

The geometry information quantization unit 1020 is configured to quantize position information of the input point cloud after the coordinate conversion and remove points whose coordinates overlap. Note that, in a case where a quantization step size is 1, the position information of the input point cloud matches quantized position information. That is, a case where the quantization step size is 1 is equivalent to a case where quantization is not performed.

The tree analysis unit 1030 is configured to receive an input of the position information of the point cloud after quantization, and generate an occupancy code indicating which node in an encoding target space a point exists, based on a tree structure to be described later.

In this processing, the tree analysis unit 1030 is configured to generate the tree structure by recursively partitioning the encoding target space into cuboids.

Here, in a case where a point exists in a certain cuboid, the tree structure can be generated by recursively executing processing of dividing this cuboid into a plurality of cuboids until the cuboid has a predetermined size. Note that each of such cuboids is referred to as a node. Furthermore, each cuboid generated by dividing the node is referred to as a child node, and a code expressed by 0 or 1 as to whether or not a point is included in the child node is the occupancy code.

As described above, the tree analysis unit 1030 is configured to generate the occupancy code while recursively dividing the node until the node has a predetermined size.

In the present embodiment, it is possible to use a method called “Octree” of recursively performing octree division using the above-described cuboids as cubes at all times, and a method called “QtBt” of performing quadtree division and binary tree division in addition to octree division.

Here, whether or not to use “QtBt” is transmitted as control data to the point cloud decoding device 200.

Alternatively, it may be designated that Predictive coding that uses any tree configuration is to be used. In such a case, the tree analysis unit 1030 determines the tree structure, and the determined tree structure is transmitted as control data to the point cloud decoding device 200.

For example, the control data of the tree structure may be configured such that the control data can be decoded by the procedure described with reference to FIGS. 5 to 12.

The approximate-surface analysis unit 1040 is configured to generate approximate-surface information by using the tree information generated by the tree analysis unit 1030.

For example, the approximate-surface information is information obtained by approximating and expressing a region in which the point cloud exists by a small plane instead of decoding an individual point cloud in a case where a point cloud is densely distributed on the surface of an object when three-dimensional point cloud data of the object or the like is decoded.

More specifically, the approximate-surface analysis unit 1040 may be configured to generate the approximate-surface information by, for example, a method called “Trisoup”. Furthermore, when a sparse point cloud acquired by Lidar or the like is decoded, this processing can be omitted.

The geometry information encoding unit 1050 is configured to encode a syntax such as the occupancy code generated by the tree analysis unit 1030 and the approximate-surface information generated by the approximate-surface analysis unit 1040, and generate a bit stream (geometry information bit stream). Here, the bit stream may include, for example, the syntax described with reference to FIG. 4.

The encoding processing is, for example, context-adaptive binary arithmetic encoding processing. Here, for example, the syntax includes control data (flags or parameters) for controlling decoding processing of position information.

The geometry information reconfiguration unit 1060 is configured to reconfigure geometry information (a coordinate system assumed by the encoding processing, that is, the position information after the coordinate conversion in the coordinate conversion unit 1010) of each point of the encoding target point cloud data based on the tree information generated by the tree analysis unit 1030 and the approximate-surface information generated by the approximate-surface analysis unit 1040.

The frame buffer 1140 is configured to receive an input of the geometry information reconfigured by the geometry information reconfiguration unit 1060, and store the geometry information as a reference frame.

For example, the frame buffer 1140 may be configured to hold the reference frame by a method similar to the method described as for the frame buffer 2120 with reference to FIG. 7.

The stored reference frame is read from the frame buffer 1140 and used as a reference frame in a case where the tree analysis unit 1030 performs inter prediction on temporally different frames.

Here, a reference frame of which time is used for each frame may be determined based on, for example, a value of a cost function representing encoding efficiency, and information of the reference frame to be used may be transmitted as the control data to the point cloud decoding device 200.

The color conversion unit 1070 is configured to perform color conversion when input attribute information is color information. The color conversion does not necessarily need to be executed, and whether or not to execute the color conversion processing is encoded as part of the control data and transmitted to the point cloud decoding device 200.

The attribute transfer unit 1080 is configured to correct an attribute value in such a way as to minimize distortion of the attribute information based on the position information of the input point cloud, the position information of the point cloud after the reconfiguration in the geometry information reconfiguration unit 1060, and the attribute information after the color change in the color conversion unit 1070. As a specific correction method, for example, the method described in Non Patent Literature 2 can be applied.

The RAHT unit 1090 is configured to receive inputs of the attribute information after the transfer by the attribute transfer unit 1080 and the geometry information generated by the geometry information reconfiguration unit 1060, and generate residual information of each point by using a type of Haar transform called Region Adaptive Hierarchical Transform (RAHT). As specific RAHT processing, for example, the method described in Non Patent Literature 2 described above can be used.

The LoD calculation unit 1100 is configured to receive an input of the geometry information generated by the geometry information reconfiguration unit 1060, and generate a Level of Detail (LoD).

The LoD is information for defining a reference relationship (a point that refers to and a point to be referred to) for implementing predictive coding of predicting attribute information of a certain point from attribute information of another certain point, and encoding or decoding a prediction residual.

In other words, the LoD is information that defines a hierarchical structure in which each point included in the geometry information is classified into a plurality of levels, and as for a point belonging to a lower level, an attribute is encoded or decoded using attribute information of a point belonging to an upper level.

As a specific LoD determination method, for example, the method described in Non Patent Literature 2 described above may be used.

The lifting unit 1110 is configured to generate residual information by lifting processing using the LoD generated by the LoD calculation unit 1100 and the attribute information after the attribute transfer in the attribute transfer unit 1080.

As specific lifting processing, for example, the method described in Non Patent Literature 2 described above may be used.

The attribute-information quantization unit 1120 is configured to quantize the residual information output from the RAHT unit 1090 or the lifting unit 1110. Here, a case where the quantization step size is 1 is equivalent to a case where quantization is not performed.

The attribute-information encoding unit 1130 is configured to perform encoding processing using as a syntax the quantized residual information or the like output from the attribute-information quantization unit 1120, and generate a bit stream (attribute-information bit stream) related to the attribute information.

The encoding processing is, for example, context-adaptive binary arithmetic encoding processing. Here, for example, the syntax includes control data (flags and parameters) for controlling decoding processing of the

The point cloud encoding device 100 is configured to receive inputs of the position information and the attribute information of each point in a point cloud, perform the encoding processing on the position information and the attribute information, and output the geometry information bit stream and the attribute-information bit stream by the above processing.

Furthermore, the above-described point cloud encoding device 100 and point cloud decoding device 200 may be implemented as a program that causes a computer to execute each function (each step).

Note that, although the above embodiment has described the present invention by taking application of the present invention to the point cloud encoding device 100 and the point cloud decoding device 200 as an example, the present invention is not limited to such an example, and can be also similarly applied to a point cloud encoding/decoding system having each function of the point cloud encoding device 100 and the point cloud decoding device 200.

According to the present embodiment, for example, comprehensive improvement in service quality can be realized in moving image communication, and thus, it is possible to contribute to the goal 9 “Build resilient infrastructure, promote inclusive and sustainable industrialization and foster innovation” of the sustainable development goal (SDGs) established by the United Nations.

1. A point cloud decoding device comprising:
a circuit that performs inter prediction using a plurality of reference frames during Predictive coding.

2. The point cloud decoding device according to claim 1, further comprising:
a frame buffer, wherein
the frame buffer
holds a plurality of decoded frames in order from a most recently decoded frame, and
rejects an old frame when a number of frames exceeds a maximum number of frames that can be held.

3. The point cloud decoding device according to claim 1, wherein
the circuit performs global motion compensation on each of the plurality of reference frames by the inter prediction using a global motion vector for a processing target frame.

4. The point cloud decoding device according to claim 1, wherein
the circuit:
performs global motion compensation on a first reference frame using a first global motion vector on the processing target frame, and
performs global motion compensation on a second reference frame using the first global motion vector and a second global motion vector of the second reference frame for the first reference frame.

5. The point cloud decoding device according to claim 4, wherein
the circuit:
holds the first global motion vector and
reuses the first global motion vector for subsequent processing.

6. The point cloud decoding device according to claim 1, wherein
the circuit:
selects from a first reference frame a node corresponding to a parent node of a processing target node,
selects from a second reference frame a node corresponding to the node selected from the first reference frame, and
uses as a predictor a child node of the node selected from the first reference frame and the second reference frame or a child node and a grandchild node of the node selected from the first reference frame and the second reference frame.

7. The point cloud decoding device according to claim 1, wherein
the circuit:
selects a node corresponding to a parent node of a processing target node from a first reference frame and a second reference frame, and
uses as a predictor a child node of the node selected from the first reference frame and the second reference frame or a child node and a grandchild node of the node selected from the first reference frame and the second reference frame.

8. The point cloud decoding device according to claim 6, wherein
the circuit performs the inter prediction using a new predictor obtained by taking an average of all of the predictors instead of using all of the predictors.

9. The point cloud decoding device according to claim 6, wherein
the circuit performs the inter prediction using a new predictor obtained by taking an average of the child nodes or the grandchild nodes instead of using all of the predictors.

10. The point cloud decoding device according to claim 8, wherein
the circuit takes such a weighted average that more importance is attached to a predictor obtained from a reference frame temporally closer to a processing target frame.

11. The point cloud decoding device according to claim 9, wherein
the circuit takes such a weighted average that more importance is attached to a predictor obtained from a reference frame temporally closer to a processing target frame.

12. The point cloud decoding device according to claim 6, wherein
the circuit uses the child node and the grandchild node as the predictor in the first reference frame and uses only the child node as the predictor in the second reference frame such that a reference frame temporally closer to the processing target frame includes more predictors.

13. The point cloud decoding device according to claim 6, wherein
the circuit performs ranking on all of the predictors based on a certain criterion, and uses predictors a number of which is designated in advance by an upper level instead of using all of the predictors obtained from the plurality of reference frames.

14. The point cloud decoding device according to claim 1, wherein
the circuit:
allocates indices to predictors belonging to different reference frames based on an order of the reference frames to which the predictors belong, and
allocates indices to predictors belonging to a same reference frame based on a parent-child relationship of nodes.

15. The point cloud decoding device according to claim 1, wherein
the circuit allocates an index to each of a plurality of predictors based on azimuth angles of the predictors in an Angular mode.

16. The point cloud decoding device according to claim 1, wherein
the circuit allocates an index to each of a plurality of predictors based on similarity between a predictor and a parent node of a processing target node.

17. A point cloud decoding method comprising:
performing inter prediction using a plurality of reference frames during Predictive coding.

18. A program stored on a non-transitory computer-readable medium for causing a computer to function as a point cloud decoding device, wherein
the point cloud decoding device comprising:
a circuit that performs inter prediction using a plurality of reference frames during Predictive coding.
